(19) United States
(12) Patent Application Publication
(10) Pub. No.: US 2014/0298258 A1
(43) Pub. Date: Oct. 2, 2014

(54) Switch List Interactions

(71) Applicant: MICROSOFT CORPORATION, Redmond, WA (US)

(72) Inventors: Christopher Doan, Seattle, WA (US); Jon Gabriel Clapper, Seattle, WA (US)

(73) Assignee: Microsoft Corporation, Redmond, WA (US)

(21) Appl. No.: 13/852,786

(22) Filed: Mar. 28, 2013

(51) Int. Cl. G06F 3/0482

(52) U.S. Cl. CPC G06F 3/0482
USPC 715/810

(57) ABSTRACT

A graphical user interface for viewing and selecting from a list of available applications through an operating system of a computer includes a switch list. The displayed switch list can be either fully or partially displayed, or hidden. The switch list becomes partially displayed after a user selects an object from the switch list through some user input gesture, such as a swipe from the left edge of the display when the switch list is hidden, or a selection and drag of an object from a fully displayed switch list. The switch list transitions from partially displayed or hidden to fully displayed when a user indicates, through some user gesture, that a currently active object is being placed back into the switch list.

### BACKGROUND

Today's personal computers, mobile devices, tablets and other computing devices generally allow a user to have multiple applications running at the same time. Thus, operating systems for these devices generally provide a mechanism through which a user can switch between applications. In general this mechanism is provided by a graphical user interface through which various gestures result in a change in the application being used by the user.

Challenges in designing such graphical user interfaces include, but are not limited to, providing an intuitive way to view available applications, to select from among them, and to change a selection that has been made.

### SUMMARY

This Summary introduces selected concepts in simplified form that are further described below in the Detailed Description. This Summary is intended neither to identify key or essential features of the claimed subject matter, nor to limit the scope of the claimed subject matter.

A graphical user interface for viewing and selecting from a list of available applications through an operating system of a computer includes a switch list. The switch list is partially displayed, providing a peek into the contents of the list, during gestures that manipulate a view of an application on a display.

In various implementations, the displayed switch list can be either fully or partially displayed, or hidden. The switch list becomes partially displayed after a user selects an object from the switch list through some user input gesture, such as a swipe from the left edge of the display when the switch list is hidden, or a selection and drag of an object from a fully displayed switch list. The switch list transitions from partially displayed or hidden to fully displayed when a user indicates, through some user gesture, that a currently active object is being placed back into the switch list. The transitions between states can be animated to provide a pleasing display. Similarly, the position and size of the selected objects representing applications can be animated when transitioning.

The switch list can be represented by a data structure, such as an object-oriented switch list object, which has at least states of being partially displayed, fully displayed or hidden. The list of applications maintained by the operating system can be used to identify and order the applications. Appropriate methods for displaying this switch list object depend on the state of the switch list (partially displayed, fully displayed, hidden), whether there is a transition from a prior state to be animated, the arrangement of the graphical representations of the applications in the switch list, and the position and orientation of the switch list in the display.

In an example implementation, the switch list is displayed as a vertically arranged stack of small thumbnail images on the left edge of a display area. Such a display object can be arranged horizontally, on an angle, or in a shape or other arrangement. An application can be represented by an icon or other object instead of a small thumbnail. The orientation of the switch list in or with respect to a display area also can vary.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a data flow diagram of an example computer with an operating system providing a switch list for applications.

FIG. 2 is an illustration of an example graphical user interface showing a gesture that invokes a partially displayed switch list.

FIG. 3 is an illustration of an example graphical user interface showing a gesture that invokes a fully displayed switch list.

FIG. 4 is an illustration of an example graphical user interface showing an application returned to a switch list.

FIG. 5 is an illustration of an example graphical user interface showing a gesture that returns a switch list to a partially displayed state.

FIG. 6 is a flow chart describing an example implementation of a switch list display manager.

FIG. 7 is an illustration of an example graphical user interface for multiple monitors.

FIG. 8 is a block diagram of an example computer with which components of such a system can be implemented.

### DETAILED DESCRIPTION

The following section provides an example operating environment in which a switch list can be implemented.

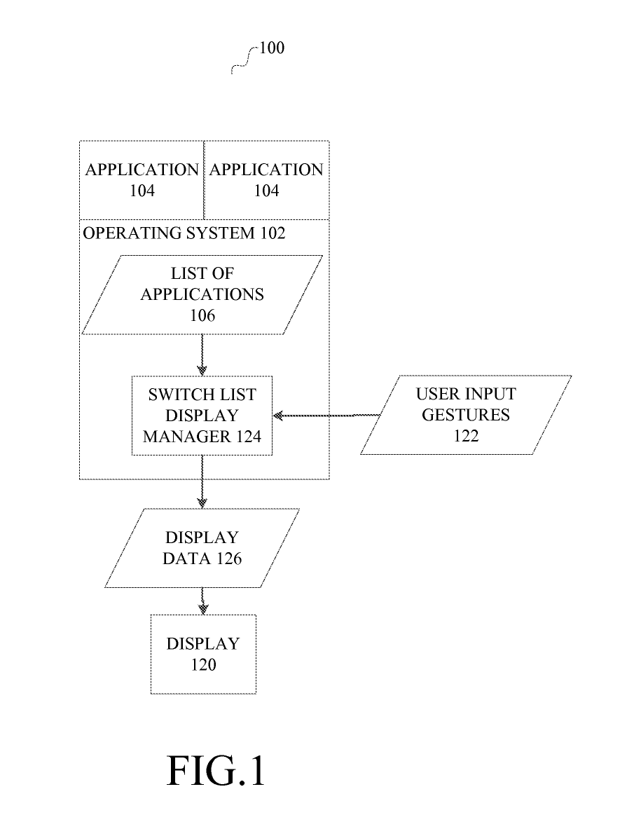

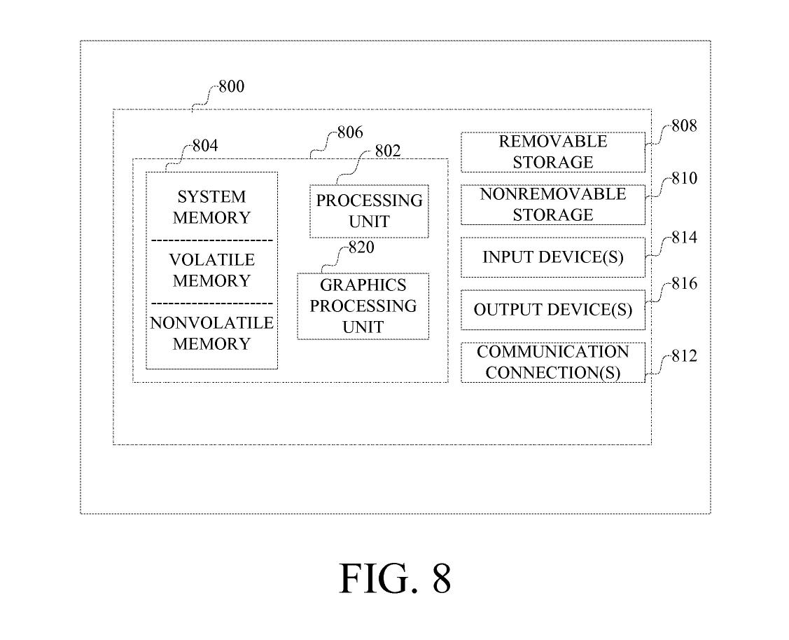

Referring to FIG. 1, a computer 100 includes an operating system 102 that manages execution of applications 104, and their access to various computer resources, such as memory, storage, input/output devices and processing resources (not shown). An example computer with which such a system can be implemented is described in more detail below in connection with FIG. 8. With multiple applications running on the computer, the operating system 102 maintains a list 106 of applications, from which a displayed version of the list can be displayed, herein called a switch list. The switch list is a data structure that identifies the application and can include other information, such as a reference to an icon representing the application, current display data for the application, and the like.

The switch list is displayed to a user on a display 120. This display is interactive, based on user input gestures 122, which can be based on inputs from a pointer device (such as a mouse) or a touch device (such as a touch screen). To provide this interactive display, the operating system has a switch list display manager 124 which receives a switch list 106 and user input gestures 122 and generates display data 126 that includes a graphical representation of the switch list for output to the display 120. As described in more detail below, in response to various user input gestures 122, the switch list display manager displays the switch list in different states, and allows a user to manipulate the items in the switch list, for example to select an application, to undo the selection of an application and to view the available applications.

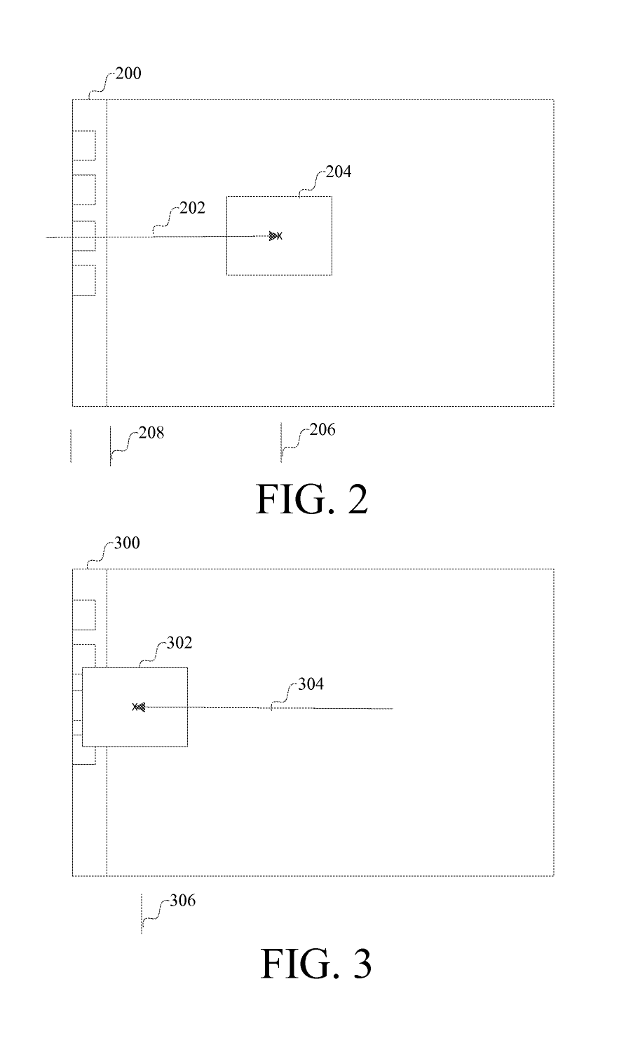

Given this context, an example implementation will be described in more detail in connection with FIGS. 2-7.

FIG. 2 illustrates an example graphical user interface for displaying a switch list. In this example, the switch list becomes partially displayed at 200, providing a peek into the contents of the switch list, after a gesture that manipulates a view of an application on a display. In this example, the gesture that is occurring is a “swipe” on a touchscreen, such as by a user placing a finger at the left edge of a display area on a touchscreen and dragging the finger into the display area, as indicated at 202. The swipe passes a threshold, as indicated at 206. This swipe gesture can be performed from any edge of a display or display area, but in this example the swipe comes from the left edge. The swipe from the left edge to the right causes a view or graphical representation 204 of an application to be displayed and then manipulated by further dragging gestures on the display. In this example, the view for an application is a large thumbnail image of a display for this application. After the swipe gesture passes a threshold, the partial view of the switch list is displayed at the left edge of the display area. In this implementation, the partial view is defined by a distance 208 from the edge of the display area which is less than the width of the fully displayed switch list. The transition of the switch list from not being displayed to being partially displayed can be animated to provide a more pleasing display.

FIG. 3 illustrates another example behavior in this graphical user interface. In this example, the switch list is already partially displayed at 300. In this example, the user gesture involves dragging the view 302 of an application to the left, as indicated at 304. In this example, the view 302 is a large thumbnail image of the display for the application. As the movement reaches a threshold 306, herein called a return threshold, from the left edge of the display area, the partial display of the switch list is expanded into a full display of the list. Such behavior also can apply when the switch list is hidden and an application has been selected and is being dragged around the display.

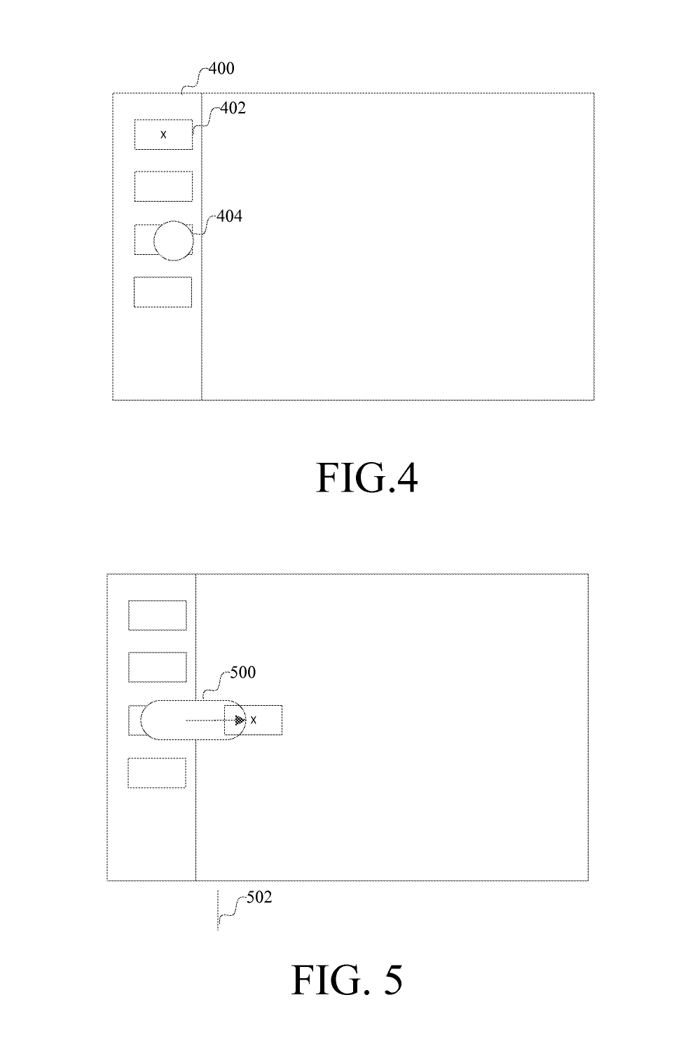

FIG. 4 illustrates, in one implementation, the consequence of the gesture involving dragging a view of an application to the left past the threshold, with the switch list fully displayed at 400. The transition from the partially displayed to the fully displayed switch list can be performed using some animation of the graphics over time, to provide a more pleasing display. The fully displayed switch list, in this example, includes a small thumbnail image of the display for each application. For the currently selected application, for which the user was dragging a large thumbnail image (view 302 in FIG. 3), a small thumbnail image 402 is now shown, which is placed in the fully displayed switch list at its position in the list. In this example, small thumbnail image 402 is displayed at the top of the switch list. The transition from the large thumbnail image to the small thumbnail image 402, in both position and size, can be animated smoothly to provide a more pleasing display to the user. A user then can select another object in the switch list, as indicated at 404.

With the switch list displayed, a user can select an item in the switch list. For example, on a touch interface a user can touch and drag one of the small thumbnail images 404 from the displayed switch list to a main area on the display. Similarly, using a pointing device, a user can click and drag one of the small thumbnail images 404 from the displayed switch list to a main area on the display.

FIG. 5 illustrates, in one implementation, conditions under which selection of an object from the fully displayed switch list results in transitioning of the switch list from fully displayed to partially displayed. In FIG. 5, if the selection and dragging, as indicated to 500, of an object results in the object being dragged past a threshold 502 beyond the edge of the displayed switch list, then the switch list transitions to a partially displayed view. This action results in a view of the switch list and the object representing the selected application which is similar to FIG. 2. The transitions from fully displayed to partially displayed switch list, and from a small thumbnail image to a large thumbnail image of the selected object, can be animated to provide a pleasing display.

Given the foregoing example implementations, the switch list is displayed as a vertically arranged stack of small thumbnail images on the left edge of a display area. Such a display object can be arranged horizontally, on an angle, or in a shape or other arrangement. An application can be represented by an icon or other object instead of a small thumbnail. The orientation in or with respect to a display area also can vary.

In various implementations, the displayed switch list can be either fully or partially displayed, or hidden. The switch list becomes partially displayed after a user selects an object from the switch list through some user input gesture, such as a swipe from the left edge of the display when the switch list is hidden, or a selection and drag of an object from a fully displayed switch list. The switch list transitions from partially displayed or hidden to fully displayed when a user indicates, through some user gesture, that a currently active object is being placed back into the switch list. The transitions between states can be animated to provide a pleasing display. Similarly, the position and size of the selected objects representing applications can be animated when transitioning.

Accordingly, the switch list can be represented by a data structure, such as an object-oriented switch list object, which has at least states of being partially displayed, fully displayed or hidden. The list of applications maintained by the operating system can be used to identify and order the applications. Appropriate methods for displaying this switch list object depend on the state of the switch list (partially displayed, fully displayed, hidden), whether there is a transition from a prior state to be animated, the arrangement of the graphical representations of the applications in the switch list, and the position and orientation of the switch list in the display.

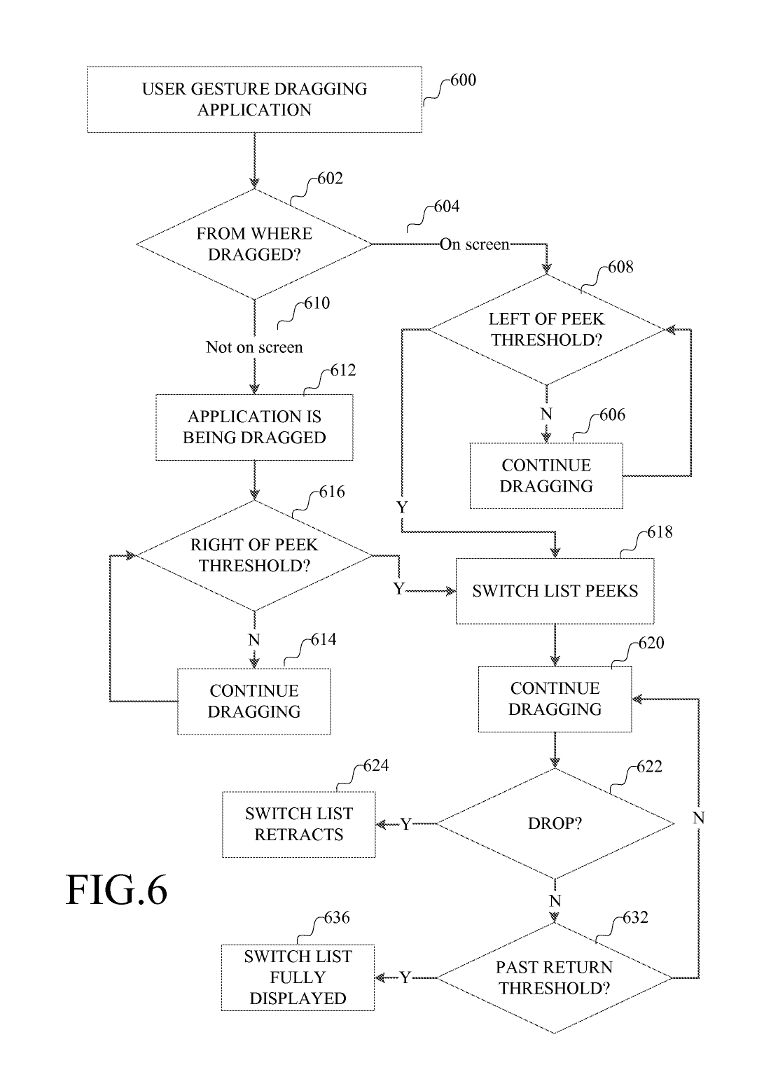

If view of the foregoing, a flowchart is shown in FIG. 6 describing a process for maintaining a graphical user interface with such a switch list.

The flowchart of FIG. 6 begins with responding to a gesture that involves dragging 600 a graphical representation of an application, such as a large thumbnail image. The system determines 602 from where the application is being dragged.

If the application was already on screen, as indicated at 604, then the application can continue to be dragged around the screen, and the switch list remains 606 in its current state until the application is to the left of the peek threshold, as determined at 608. Initiating the drag operation can be caused by several different gestures, such as by being selected from the switch list or being minimized through a gesture (such as a swipe from the top edge of the screen), or yet other gestures.

Similarly, if the application was not on screen, as indicated at 610, then the application is being dragged, as indicated at 612. Initiating the drag operation can be caused by several different gestures, such as dragging in from an edge of the display (in this example implementation), or yet other gestures. The application can continue to be dragged on the screen, as indicated at 614, and the switch list remains in its current state, until the application is dragged to the right of the peek threshold, as determined at 616. If the gesture originated from a location on the display that is not where the switch list is displayed, for an application that was the currently active application, and the switch list is hidden, then the full display of the switch list can be invoked when a threshold is passed.

Note that the orientation of the switch list on the display determines the direction of movement over the peek threshold that invokes the partially displayed switch list. If the switch list is displayed on the left edge of the display area, then when dragged view of the application begins on screen, the peek threshold is passed going to the left. When the dragged view of the application begins off screen to the left, the peek threshold is passed going to the right. In general, when the dragged view of the application is on screen, movement towards the displayed location of the switch list invokes the switch list; when the dragged view of the application is off screen near the switch list, movement away from the displayed location of the switch list invokes the switch list.

In this example implementation, when the view of an application is dragged past the peek threshold, as determined at 608 or 616, the switch list changes state to the partially displayed view as indicated at 618. At this transition, the display of the switch list, and the display of any graphical representation of any currently selected application, can be animated, in both position and size, to provide for a pleasing display.

While the switch list is partially displayed, a user can continue to manipulate the graphical representation of the currently selected application, as indicated at 620. If the user releases the application, such as by a “drop” gesture, as indicated at 622, the switch list retracts 624 from view (its state changes to hidden).

If the user drags the application back in the direction of the partially displayed switch list, the system determines whether it is dragged within the return threshold, as indicated at 632. If the application is not within the return threshold, then the user can continue to manipulate the application, such as by further dragging it around the display, as indicated at 620. If the application is dragged within the return threshold, then the switch list changes state to fully displayed, as indicated at 636. At this stage, the user can return the application to the switch list.

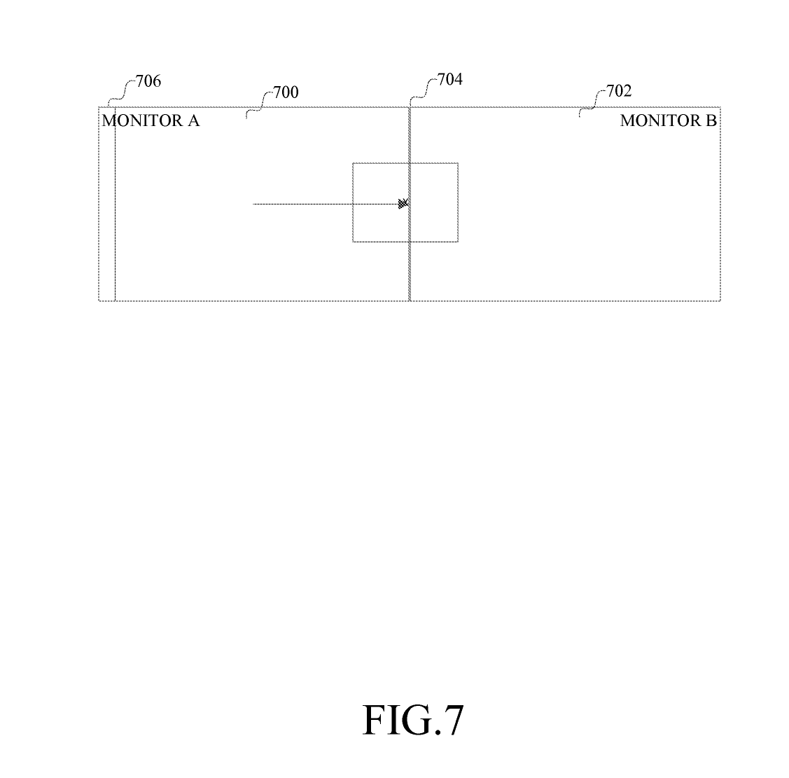

Having now described an example implementation using a single display area, FIG. 7 will now be described to address an implementation applicable to a system that is using multiple monitors (displays).

For example, it is desirable to allow a user to manipulate an application (it graphical representation, such as a large thumbnail image) among multiple monitors. However, the various thresholds for causing the switch list to be partially displayed or fully displayed are related to the monitor on which the switch list is displayed.

In an example implementation, referring to FIG. 7, given monitor A (700) and monitor B (702), a cursor or other object can move from being displayed on monitor A to being displayed on monitor B, as indicated at 704. In this case, if the switch list is currently partially displayed on monitor A at 706, then the switch list can become hidden after the transition of the object to monitor B.

Other conditions can be placed on the switch list display. For example, if the switch list is displayed on the left edge of a display area, then it is displayed only on monitors that have a completely unshared (with other monitors) left edge, whether the switch list is partially or fully displayed. Similar conditions can be applied to other switch list placements. Also, the switch list is partially displayed on the monitor that has a current cursor location. Thus, if the cursor switches over to another monitor, then the partially displayed switch list is removed. Similarly, if the switch list is partially displayed on a monitor, then it becomes fully displayed only in response to gestures on the same monitor that drag an application to the return threshold (see FIG. 4).

Having now described an example implementation, a computer with which components of such a system are designed to operate will now be described. The following description is intended to provide a brief, general description of a suitable computer with which such a system can be implemented. The computer can be any of a variety of general purpose or special purpose computing hardware configurations. Examples of well-known computers that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

FIG. 8 illustrates an example of a suitable computer. This is only one example of a suitable computer and is not intended to suggest any limitation as to the scope of use or functionality of such a computer.

With reference to FIG. 8, an example computer 800, in a basic configuration, includes at least one processing unit 802 and memory 804. The computer may include multiple processing units and/or additional co-processing units such as graphics processing unit 820. Depending on the exact configuration and type of computer, memory 804 may be volatile (such as RAM), non-volatile (such as ROM, flash memory, etc.) or some combination of the two. This configuration is illustrated in FIG. 8 by dashed line 806.

Additionally, computer 800 may also have additional features/functionality. For example, computer 800 may also include additional storage (removable and/or non-removable) including, but not limited to, magnetic or optical disks or tape. Such additional storage is illustrated in FIG. 8 by removable storage 808 and non-removable storage 810. Computer storage media includes volatile and nonvolatile, removable and non-removable media implemented in any method or technology for storage of information such as computer program instructions, data structures, program modules or other data. Memory 804, removable storage 808 and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer 800. Any such computer storage media may be part of computer 800.

Computer 800 may also contain communications connection(s) 812 that allow the device to communicate with other devices over a communication medium. Communication media typically carry computer program instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 812 are devices that interface with the communication media to transmit data over and receive data from communication media, such as a network interface.

Computer 800 may have various input device(s) 814 such as a keyboard, mouse, pen, camera, touch input device, and so on. Output device(s) 816 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye , and gaze tracking, immersive augmented reality and virtual reality systems, all of which provide a more natural interface, as well as technologies for sensing brain activity using electric field sensing electrodes (EEG and related methods).

Each component of this system that operates on a computer generally is implemented by software, such as one or more computer programs, which include computer-executable instructions and/or computer-interpreted instructions, such as program modules, being processed by the computer. Generally, program modules include routines, programs, objects, components, data structures, and so on, that, when processed by a processing unit, instruct the processing unit to perform particular tasks or implement particular abstract data types. This computer system enforces licensing restrictions may be practiced in distributed computing environments where tasks are performed by remote processing devices that are linked through a communications network. In a distributed computing environment, program modules may be located in both local and remote computer storage media including memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process performed by a processor in a computer, comprising:
receiving a list of applications running on the computer into memory;
generating a switch list as a graphical representation of the list of applications;
in response to a first gesture, partially displaying the switch list on the display;
in response to a second gesture, fully displaying the switch list.

2. The computer-implemented process of claim 1, wherein the first gesture indicates a selection of an application.

3. The computer-implemented process of claim 1, wherein the second gesture indicates a user intent to return an application to the switch list.

4. The computer-implemented process of claim 3, wherein the second gesture comprises, when the switch list is partially displayed, movement of an object towards the switch list and past a return threshold.

5. The computer-implemented process of claim 1, wherein the first gesture comprises, when the switch list is hidden, selection of an application and movement of a graphical representation of the selected application on the display.

6. The computer-implemented process of claim 1, wherein the first gestures comprises, when the switch list is fully displayed, selection of an application in the switch list and movement of a graphical representation of the selected application away from the switch list past a threshold.

7. The computer-implemented process of claim 1, wherein the display includes multiple monitors, and wherein the switch list becomes hidden when an object is moved from a monitor on which the switch list is displayed to another monitor.

8. An article of manufacture comprising:
a computer storage medium;
computer program instructions stored on the computer storage medium which, when processed by a processing device, instruct the processing device to perform a process comprising:
receiving a list of applications running on the computer into memory;
generating a switch list as a graphical representation of the list of applications;
in response to a first gesture, partially displaying the switch list on the display;
in response to a second gesture, fully displaying the switch list.

9. The article of manufacture of claim 8, wherein the first gesture indicates a selection of an application.

10. The article of manufacture of claim 8, wherein the second gesture indicates a user intent to return an application to the switch list.

11. The article of manufacture of claim 10, wherein the second gesture comprises, when the switch list is partially displayed, movement of an object towards the switch list and past a return threshold.

12. The article of manufacture of claim 8, wherein the first gesture comprises, when the switch list is hidden, selection of an application and movement of a graphical representation of the selected application on the display.

13. The article of manufacture of claim 8, wherein the first gestures comprises, when the switch list is fully displayed, selection of an application in the switch list and movement of a graphical representation of the selected application away from the switch list past a threshold.

14. The article of manufacture of claim 8, wherein the display includes multiple monitors, and wherein the switch list becomes hidden when an object is moved from a monitor on which the switch list is displayed to another monitor.

15. A computer comprising:
a memory,
a processor connected to the memory and programmed to:
receive a list of applications running on the computer into memory;
generate a switch list as a graphical representation of the list of applications;
in response to a first gesture, partially display the switch list on the display;
in response to a second gesture, fully display the switch list.

16. The computer of claim 15, wherein the first gesture indicates a selection of an application.

17. The computer of claim 15, wherein the second gesture comprises, when the switch list is hidden, selection and movement of an object towards the switch list and past a threshold.

18. The computer of claim 15, wherein the first gesture comprises, when the switch list is hidden, selection of an application and movement of a graphical representation of the selected application on the display.

19. The computer of claim 15, wherein the first gestures comprises, when the switch list is fully displayed, selection of an application in the switch list and movement of a graphical representation of the selected application away from the switch list past a threshold.

20. The computer of claim 15, wherein the display includes multiple monitors, and wherein the switch list becomes hidden when an object is moved from a monitor on which the switch list is displayed to another monitor.
